(19) United States
(12) Patent Application Publication
(10) Pub. No.: US 2015/0237226 A1
(43) Pub. Date: Aug. 20, 2015

(54) PRINTING INSTRUCTION APPARATUS, IMAGE FORMING SYSTEM, PRINTING INSTRUCTION METHOD, AND COMPUTER READABLE MEDIUM

(71) Applicant: FUJI XEROX CO., LTD., Tokyo (JP)

(72) Inventor: Makoto KONDO, Kanagawa (JP)

(73) Assignee: FUJI XEROX CO., LTD., Tokyo (JP)

(21) Appl. No.: 14/469,160

(22) Filed: Aug. 26, 2014

(30) Foreign Application Priority Data
Feb. 17, 2014 (JP) 2014-027967

(51) Int. Cl. H04N 1/00; G06F 3/12

(52) U.S. Cl. CPC H04N 1/00474; H04N 1/00925; H04N 1/00129; H04N 1/00204; H04N 1/00408; G06F 3/1258; H04N 2201/0075; H04N 2201/0094

(57) ABSTRACT

A printing instruction apparatus includes a display, a reception unit, and a changing unit. The display displays a selection screen for allowing a user to select an execution function, which is a printing function to be executed, from among printing functions provided in plural printing apparatuses. The reception unit receives a selection of the execution function. The changing unit changes the selection screen so that, after the reception unit receives the selection of the execution function, a printing function executable by a printing apparatus which has the execution function that has already been received by the reception unit is selectable and the other printing functions are not selectable.

### CROSS-REFERENCE TO RELATED APPLICATIONS

This application is based on and claims priority under 35 USC 119 from Japanese Patent Application No. 2014-027967 filed Feb. 17, 2014.

### BACKGROUND

1. Technical Field

The present invention relates to a printing instruction apparatus, an image forming system, a printing instruction method, and a computer readable medium.

2. Summary

According to an aspect of the invention, there is provided a printing instruction apparatus including a display, a reception unit, and a changing unit. The display displays a selection screen for allowing a user to select an execution function, which is a printing function to be executed, from among printing functions provided in plural printing apparatuses. The reception unit receives a selection of the execution function. The changing unit changes the selection screen so that, after the reception unit receives the selection of the execution function, a printing function executable by a printing apparatus which has the execution function that has already been received by the reception unit is selectable and the other printing functions are not selectable.

### BRIEF DESCRIPTION OF THE DRAWINGS

Exemplary embodiments of the present invention will be described in detail based on the following figures, wherein:

FIG. 1 is a diagram illustrating the entire configuration of an image forming system to which an exemplary embodiment is applied;

FIG. 2 illustrates an example of the functional configuration of a terminal apparatus to which an exemplary embodiment is applied;

FIG. 3 is a diagram illustrating a hardware configuration of a terminal apparatus;

FIG. 4 is a diagram illustrating printing functions provided in image forming apparatuses;

FIGS. 5A to 5B, FIGS. 5C-1 to 5C-2, FIGS. 5D-1 to 5D-2, and FIGS. 5E-1 to 5E-2 are conceptual diagrams illustrating relationships between printing functions provided in image forming apparatuses and selected functions;

FIGS. 6A to 6C are diagrams illustrating examples of a printing instruction screen;

FIGS. 6D and 6E are diagrams illustrating examples of a printing instruction screen;

FIG. 7 is a flowchart illustrating an example of an operation of a printer driver at the time of initial setting;

FIG. 8 is a flowchart illustrating an example of an operation of a printer driver at the time of printing;

FIGS. 9A and 9B are diagrams illustrating examples of a screen displayed on a display mechanism of a terminal apparatus; and

FIG. 10 is a diagram illustrating an example of a screen displayed on a display mechanism of a terminal apparatus according to a variation.

### DETAILED DESCRIPTION

Hereinafter, exemplary embodiments of the present invention will be described in detail with reference to the attached drawings.

### <Image Forming System 1>

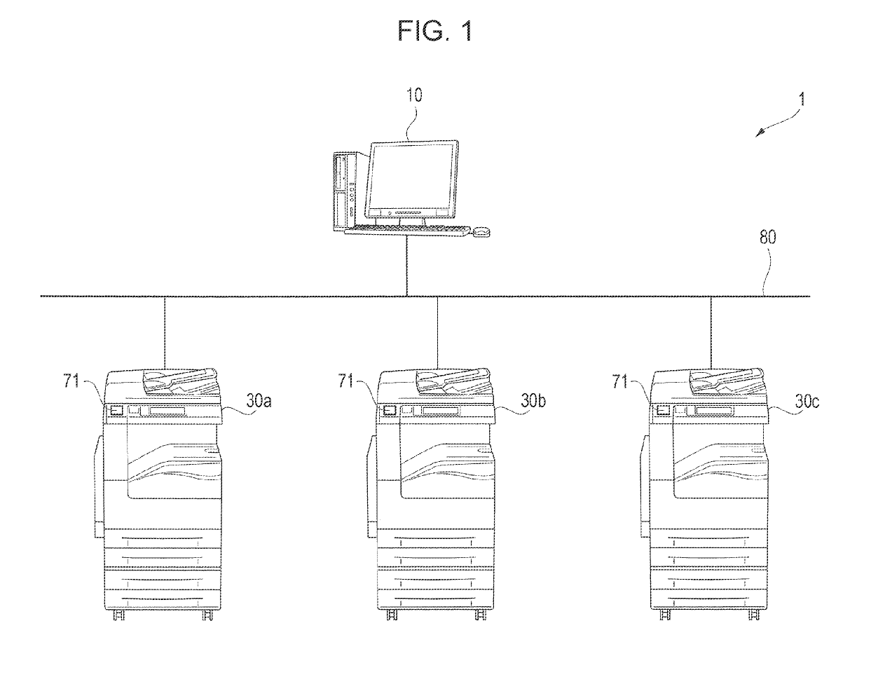

FIG. 1 illustrates an example of the configuration of an image forming system 1 to which an exemplary embodiment is applied.

As illustrated in FIG. 1, the image forming system 1 is configured such that a terminal apparatus 10 and image forming apparatuses 30a, 30b, and 30c are connected via a network 80.

The terminal apparatus 10, which is an example of a printing instruction apparatus, is a computer apparatus that instructs the image forming apparatuses 30a, 30b, and 30c to perform printing. In this exemplary embodiment, the terminal apparatus 10 may be, for example, a personal computer (PC), and the PC may operate as a client PC or a server PC.

The image forming apparatuses 30a, 30b, and 30c, which are examples of printing apparatuses, each have an image forming function of forming an image on a medium, such as paper, and the like. The image forming apparatuses 30a, 30b, and 30c may be, for example, multifunction apparatuses having an image reading function of reading an image from a medium, such as paper, and a FAX function, as well as the image forming function (printing function). The illustrated image forming apparatuses 30a, 30b, and 30c each include an IC card reading unit 71 that reads information held in an IC card in response to, for example, as a trigger, holding the IC card over the IC card reading unit 71 by a user. Further, although the image forming apparatuses are denoted by different reference signs in FIG. 1, the image forming apparatuses may each be represented by an “image forming apparatus 30” in the description provided below when attention is paid to any one of them.

The network 80 is a communication line network used for performing information communication between the terminal apparatus 10 and the image forming apparatuses 30a, 30b, and 30c. In this exemplary embodiment, the network 80 may be a local area network (LAN) or the Internet.

### <Terminal Apparatus 10>

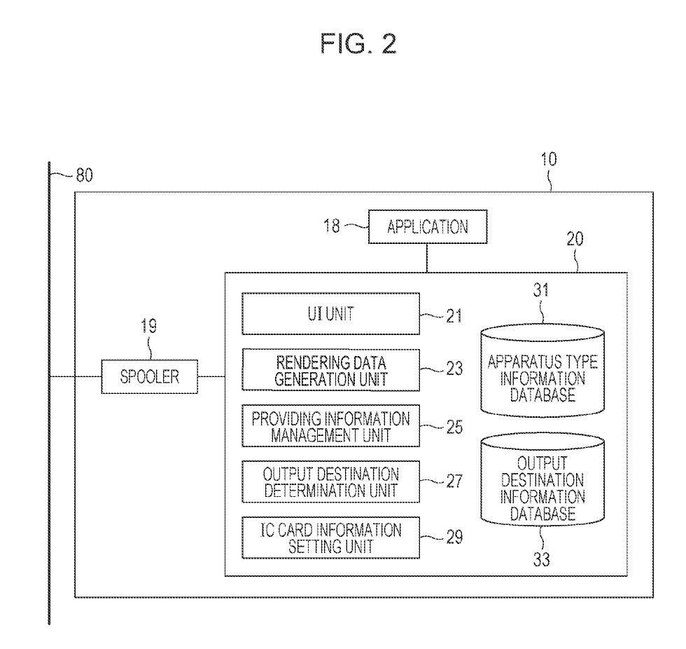

FIG. 2 illustrates an example of the functional configuration of the terminal apparatus 10 to which an exemplary embodiment is applied.

As illustrated in FIG. 2, in the terminal apparatus 10, an application program (hereinafter, represented by an “application”) 18, a spooler 19, and a printer driver 20 operate.

The application 18 is a program which creates document data and fetches the created document data, in accordance with a user's operation.

The spooler 19 is a program which temporarily stores printing instruction data generated at the printer driver 20, extracts printing instruction data in accordance with a predetermined rule, and sends the printing instruction data to the image forming apparatuses 30.

The printer driver 20 is a program which controls output of documents from the image forming apparatuses 30 by transmitting printing instruction data to the image forming apparatuses 30 via the spooler 19 when requests for printing based on document data are issued from the application 18. In this exemplary embodiment, printing instruction data is, for example, page description language (PDL) data written in a PDL. Further, the printing instruction data includes image quality instructions, which are instructions regarding image quality, such as resolution, gradation information, and screen, and rendering commands, which are instructions for rendering characters, drawings, images, and the like.

The terminal apparatus 10 includes, as functions of the printer driver 20, a user interface (UI) unit 21, a rendering data generation unit 23, a providing information management unit 25, an output destination determination unit 27, an IC card information setting unit 29, an apparatus type information database 31, and an output destination information database 33.

The UI unit 21 functions as a user interface with a user. That is, the UI unit 21 presents information to a user and receives an operation from the user.

The rendering data generation unit 23 generates printing instruction data for instructing the image forming apparatuses 30 to perform printing based on document data for which a printing instruction is issued by the application 18.

The providing information management unit 25 manages information to be provided (presented) to a user via the UI unit 21, based on information stored in the apparatus type information database 31.

The output destination determination unit 27 determines in which one of the image forming apparatuses 30a, 30b, and 30c image information is to be performed, that is, determines an output destination, based on a user's operation received via the UI unit 21.

The IC card information setting unit 29 receives information held in an IC card, and stores therein the received information.

The apparatus type information database 31 stores therein apparatus type information, which is information regarding printing functions provided in the image forming apparatuses 30a, 30b, and 30c.

The output destination information database 33 stores therein output destination information, such as the apparatus type name (model name), model number, and IP address of each of the image forming apparatuses 30a, 30b, and 30c, which is information for identifying the image forming apparatus 30a, 30b, or 30c serving as an output destination, in accordance with, for example, an instruction from a user.

In this exemplary embodiment, the UI unit 21, the apparatus type information database 31, and the output destination information database 33 are provided as an example of a display. Further, the UI unit 21 is provided as an example of an acquisition unit, a reception unit, and a cancellation unit. Further, the providing information management unit 25 is provided as a changing unit, an identifying unit, and a restriction unit. Further, the output destination determination unit 27 is provided as an example of a designation unit.

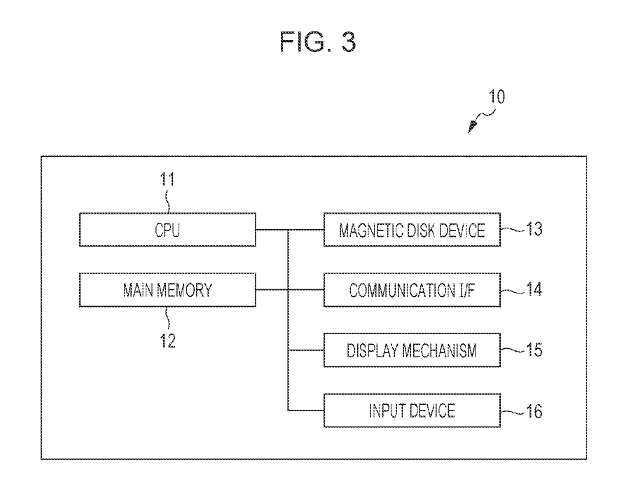

FIG. 3 is a diagram illustrating a hardware configuration of the terminal apparatus 10.

A hardware configuration of the terminal apparatus 10 will now be explained.

The terminal apparatus 10 includes a central processing unit (CPU) 11, a main memory 12, and a magnetic disk device (hard disk drive (HDD)) 13. The CPU 11 serves as a calculation unit, and the main memory 12 and the magnetic disk device 13 serve as a memory. The CPU 11 executes various types of software, such as an operating system (OS) and an application, and implements the various functions described above. Further, the main memory 12 is a storage region in which the various types of software, data to be used for execution of the various types of software, and the like are stored. The magnetic disk device 13 is a storage region in which data to be input to the various types of software, data output from the various types of software, and the like are stored.

The terminal apparatus 10 further includes a communication I/F 14 for performing communication with an external apparatus, a display mechanism 15 including a video memory, a display, and the like, and an input device 16 including a keyboard, a mouse, and the like.

<Printing Functions Provided in Image Forming Apparatuses 30a, 30b, and 30c>

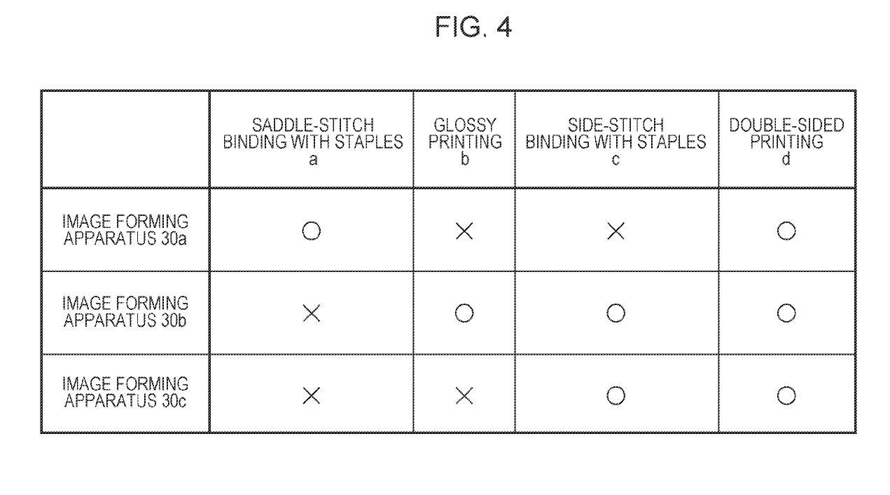

FIG. 4 is a diagram illustrating printing functions provided in the image forming apparatuses 30a, 30b, and 30c. In FIG. 4, “o” marks indicate that corresponding printing functions are provided in (supported by) corresponding image forming apparatuses 30a, 30b, and 30c, and “x” marks indicate that corresponding printing functions are not provided in (supported by) corresponding image forming apparatuses 30a, 30b, and 30c.

Referring to FIG. 4, the image forming apparatuses 30a, 30b, and 30c have different printing functions.

Printing functions provided in the image forming apparatuses 30a, 30b, and 30c will now be explained. First, the image forming apparatus 30a has a printing function of saddle-stitch binding with staples a and a printing function of double-sided printing d. The image forming apparatus 30b has a printing function of glossy printing b, a printing function of side-stitch binding with staples c, and the printing function of double-sided printing d. The image forming apparatus 30c has the printing function of side-stitch binding with staples c and the printing function of double-sided printing d.

In other words, only the image forming apparatus 30a has the printing function corresponding to the saddle-stitch binding with staples a. Similarly, only the image forming apparatus 30b has the printing function corresponding to the glossy printing b. The image forming apparatuses 30b and 30c each have the printing function corresponding to the side-stitch binding with staples c. The image forming apparatuses 30a, 30b, and 30c each have the printing function corresponding to the double-sided printing d.

Although the saddle-stitch binding with staples a, the glossy printing b, the side-stitch binding with staples c, and the double-sided printing d are exemplified as printing functions in this exemplary embodiment, printing functions are not limited to the functions mentioned above. For example, printing functions may include punching processing for forming holes in paper, N-up printing for allocating N pages (logical pages) of an electronic document to one page (physical page) of paper, and the like.

Further, for example, in the case where N-up printing is provided as a printing function, processing (allocation processing) for allocating N pages of an electronic document to one page of paper for implementing N-up printing may be performed by the terminal apparatus 10, may be performed by the image forming apparatus 30a, 30b, or 30c, or may be performed by both the terminal apparatus 10 and the image forming apparatus 30a, 30b, or 30c.

### <Operation of Printer Driver 20>

An operation of the printer driver 20 in an exemplary embodiment will now be explained.

First, functional restriction of a common printer driver, which is a general technique, will be explained. Next, an operation concept of the printer driver 20 in this exemplary embodiment will be explained. Finally, an operation of the printer driver 20 will be specifically explained.

### <Functional Restriction of Common Printer Driver>

As illustrated in FIG. 1, in the image forming system 1 that is capable of image formation using the image forming apparatuses 30a, 30b, and 30c, a common printer driver which may be used in common among the image forming apparatuses 30a, 30b, and 30c may be used as a general technique. The common printer driver is, for example, a printer driver which is able to be operated (output) in common for image forming apparatuses manufactured by a manufacturer of the image forming apparatuses 30a, 30b, and 30c.

In the case where a common printer driver has been installed into the terminal apparatus 10, even when, for example, a new image forming apparatus (not illustrated) which is different from the image forming apparatuses 30a, 30b, and 30c is introduced, there is no need to install a different printer driver into the terminal apparatus 10. Thus, the cost to be used when a new image forming apparatus is introduced may be reduced. Further, in the case where a common printer driver is used, unlike the case where different printer drivers for operating the image forming apparatuses 30a, 30b, and 30c are individually provided, only one icon indicating the common printer driver needs to be displayed on the display mechanism 15 of the terminal apparatus 10 (see FIG. 3).

For example, as illustrated in FIG. 4, when the image forming apparatuses 30a, 30b, and 30c have different printing functions, the common printer driver may be configured to provide only printing functions that are provided in common in all the plural image forming apparatuses 30a, 30b, and 30c. That is, the common printer may be configured based on the intersection of the printing functions provided in the image forming apparatuses 30a, 30b, and 30c. In the example of FIG. 4, the common printer is configured to provide the printing function corresponding to the double-sided printing d.

However, with such a common printer driver that is configured based on the intersection of printing functions, a state where some of printing functions provided in the image forming apparatuses 30a, 30b, and 30c are not provided, that is, functional restriction, may occur. In the example of FIG. 4, the common printer driver does not provide the printing functions corresponding to the saddle-stitch binding with staples a, the glossy printing b, and the side-stitch binding with staples c.

### <Concept of Operation of Printer Driver 20>

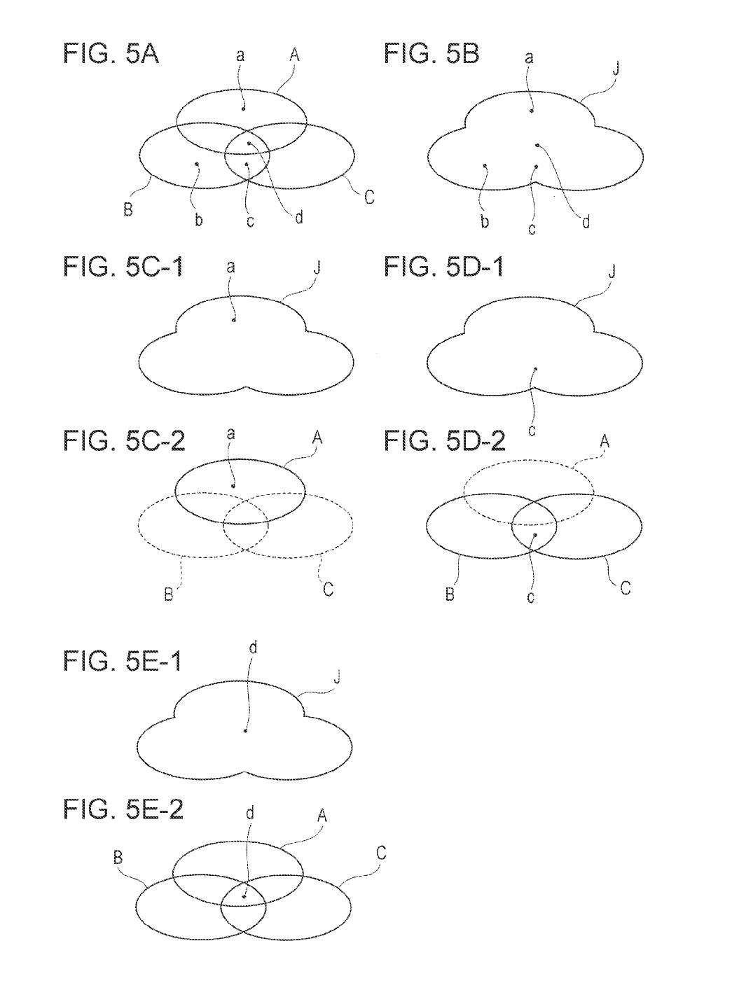

FIGS. 5A to 5B, FIGS. 5C-1 to 5C-2, FIGS. 5D-1 to 5D-2, and FIGS. 5E-1 to 5E-2 are conceptual diagrams illustrating the relationships between printing functions provided in the image forming apparatuses 30a, 30b, and 30c and selected functions. In FIGS. 5A to 5E-2, sets A, B, and C represent sets of the printing functions provided in the image forming apparatuses 30a, 30b, and 30c, respectively, and signs a, b, c, and d represent the printing functions corresponding to the saddle-stitch binding with staples a, the glossy printing b, the side-stitch binding with staples c, and the double-sided printing d, respectively.

The printer driver 20 in this exemplary embodiment is configured to be able to output in common to the image forming apparatuses 30a, 30b, and 30c and not to generate the functional restriction described above.

Specifically, the printer driver 20 in this exemplary embodiment is configured to be able to identify printer types of the image forming apparatuses 30a, 30b, and 30c installed in the image forming system 1, that is, printing functions provided in the image forming apparatuses 30a, 30b, and 30c, and to perform all the identified printing functions.

Further, the printer driver 20 in this exemplary embodiment performs restriction of printing functions among all the identified printing functions by narrowing down output destination candidates from among the image forming apparatuses 30a, 30b, and 30c, in response to reception of an instruction from a user.

A concept of an operation of the printer driver 20 will now be explained.

First, it is assumed that the sets A, B, C, which are printing functions provided in the image forming apparatuses 30a, 30b, and 30c, respectively, are different from one another, as described above. That is, as illustrated in FIG. 5A, the sets A, B, and C partially overlap, that is, the sets A, B, C do not completely overlap.

Next, as illustrated in FIG. 5B, the printer driver 20 according to this exemplary embodiment identifies printing functions provided in the image forming apparatuses 30a, 30b, and 30c, and calculates a set J, which is the union of the sets A, B, and C. Then, the setting of the printer driver 20 is changed so that all the printing functions in the set J (in the example of FIG. 5B, the printing functions corresponding to the saddle-stitch binding with staples a, the glossy printing b, the side-stitch binding with staples c, and the double-sided printing d) are able to be performed.

Next, as illustrated in FIGS. 5C-1 to 5C-2, FIGS. 5D-1 to 5D-2, and FIGS. 5E-1 to 5E-2, the printer driver 20 makes a selection (first selection) of a printing function to be performed when a user causes an image forming apparatus 30 to output a document, and identifies an image forming apparatus 30 that supports the selected printing function. Then, the printer driver 20 allows only printing functions provided in the identified image forming apparatus 30 to be selectable when the user further makes a selection (second selection) of a printing function.

A specific explanation will be provided on the assumption that the user selects the printing function corresponding to the saddle-stitch binding with staples a in the set J, as illustrated in FIG. 5C-1. All the image forming apparatuses 30a, 30b, and 30c do not have the printing function corresponding to the saddle-stitch binding with staples a. That is, only the image forming apparatus 30a has the printing function corresponding to the saddle-stitch binding with staples a (see FIG. 4). Thus, the printer driver 20 changes the setting so that only printing functions provided in the image forming apparatus 30a, which has the printing function corresponding to the saddle-stitch binding with staples a (see FIG. 4), are available. That is, as illustrated in FIG. 5C-2, only the printing functions in the set A become available.

When the printing function corresponding to the side-stitch binding with staples c is selected as illustrated in FIG. 5D-1, the printer driver 20 changes the setting so that only printing functions provided in the image forming apparatuses 30b and 30c, which have the printing function corresponding to the side-stitch binding with staples c (see FIG. 4), are available. That is, as illustrated in FIG. 5D-2, the printing functions in the sets B and C become available.

Further, when the printing function corresponding to the double-sided printing d is selected as illustrated in FIG. 5E-1, the printer driver 20 performs setting so that printing functions provided in the image forming apparatuses 30a, 30b, and 30c, which have the printing function corresponding to the double-sided printing d (see FIG. 4), are available. In this case, as illustrated in FIG. 5E-2, the sets A, B, and C are available, which is the same as the state before the double-sided printing d is selected.

As described above, the printer driver 20 according to this exemplary embodiment first allows all the printing functions available in the image forming apparatuses 30a, 30b, and 30c in the image forming system 1 to be available. When a user selects a printing function (or an option) that is available only in a specific apparatus type among the image forming apparatuses 30a, 30b, and 30c, the printer driver 20 narrows down output destination candidates from the image forming apparatuses 30a, 30b, and 30c. In accordance with the narrowing-down, restriction of printing functions other than the selected printing function is determined, and output destinations (ports) are narrowed down.

### <Specific Operation of Printer Driver 20>

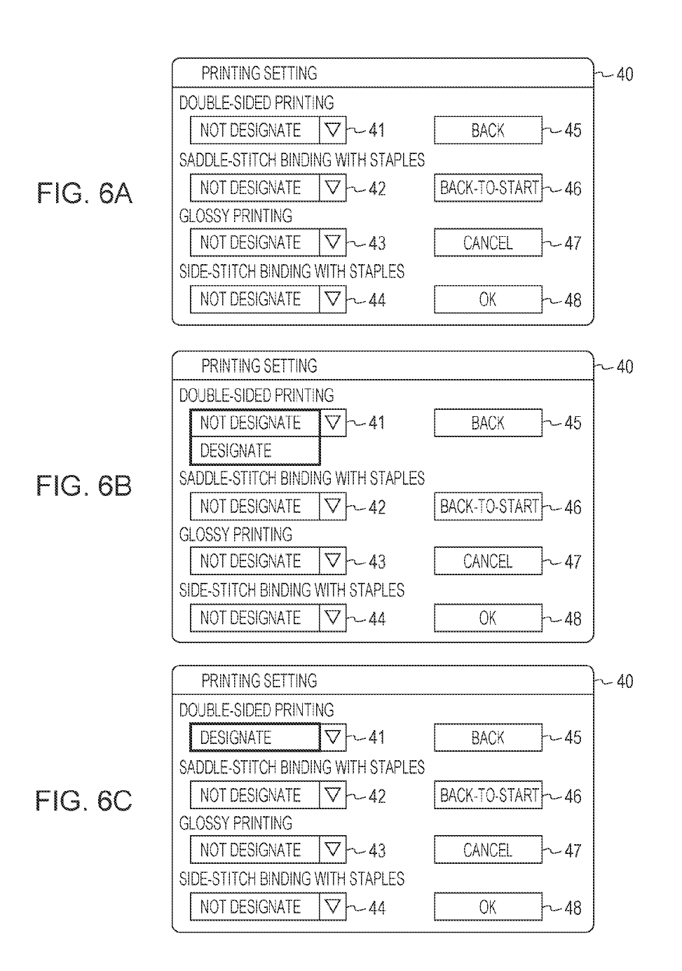

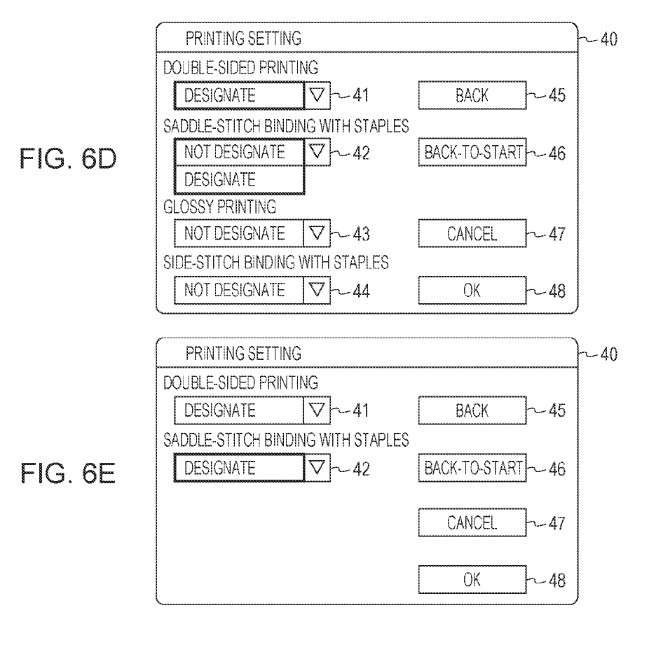

FIGS. 6A to 6C and FIGS. 6D to 6E are diagrams illustrating examples of a printing instruction screen. In FIGS. 6A to 6C and FIGS. 6D to 6E, the image forming apparatuses 30a, 30b, and 30c which receive a printing instruction from the terminal apparatus 10 have the printing functions illustrated in FIG. 4.

A specific operation of the printer driver 20 will now be explained with reference to FIGS. 2 to 4, FIGS. 5A to 5B, FIGS. 5C-1 to 5C-2, FIGS. 5D-1 to 5D-2, FIGS. 5E-1 to 5E-2, FIGS. 6A to 6C, and FIGS. 6D to 6E. First, a change in a printing instruction screen which is caused by the printer driver 20 to be displayed on the display mechanism 15 of the terminal apparatus 10 will be explained. Next, an operation of the printer driver 20 will be explained in detail.

The providing information management unit 25 of the printer driver 20 calculates the set J, which is the union of the printing functions provided in the image forming apparatuses 30a, 30b, and 30c, based on apparatus type information stored in the apparatus type information database 31, in response to an instruction from a user as a trigger. The set J in the example illustrated in FIG. 5B includes the printing functions corresponding to the saddle-stitch binding with staples a, the glossy printing b, the side-stitch binding with staples c, and the double-sided printing d.

Based on the calculated set J, the UI unit 21 displays, for example, a printing instruction screen 40 illustrated in FIG. 6A on the display mechanism 15. The printing instruction screen 40, which is an example of a selection screen, includes parts for designating the printing functions included in the set J, that is, a designation part 41 for designating double-sided printing, a designation part 42 for designating saddle-stitch binding with staples, a designation part 43 for designating glossy printing, and a designation part 44 for designating side-stitch binding with staples. The printing instruction screen 40 also includes a back button 45, a back-to-start button 46, a cancel button 47, and an OK button 48.

The designation part 41 receives designation of the double-sided printing d. Specifically, in accordance with an operation by a user, a list of “designate” and “not designate” for the double-sided printing d is displayed in the designation part 41. In accordance with the list display, the user performs designation of the double-sided printing d.

The designation part 42 receives designation of the saddle-stitch binding with staples a. Specifically, in accordance with an operation by a user, a list of “designate” or “not designate” for the saddle-stitch binding with staples a is displayed in the designation part 42. In accordance with the list display, the user performs designation of the saddle-stitch binding with staples a.

The designation part 43 receives designation of the glossy printing b. Specifically, in accordance with an operation by a user, a list of “designate” and “not designate” for the glossy printing b is displayed in the designation part 43. In accordance with the list display, the user performs designation of the glossy printing b.

The designation part 44 receives designation of the side-stitch binding with staples c. Specifically, in accordance with an operation by a user, a list of “designate” and “not designate” for the side-stitch binding with staples c is displayed in the designation part 44. In accordance with the list display, the user performs designation of the side-stitch binding with staples c.

When the back button 45 is depressed, the designation state is returned to the state immediately before the last designation of a printing instruction performed by a user. That is, the last designation of a printing instruction is canceled. With the use of the back button 45, an operation by a user to designate a printing function becomes easier.

When the back-to-start button 46 is depressed, all the designations of printing functions performed by a user during a period from displaying of the printing instruction screen 40 to the depressing of the back-to-start button 46, are returned to the original state. That is, all the designations of printing functions are canceled. With the user of the back-to-start button 46, an operation by a user to designate a printing function becomes easier.

When the cancel button 47 is depressed, an operation for receiving a printing instruction by the printer driver 20 is terminated. That is, when the cancel button 47 is depressed, the printing instruction screen 40 is erased.

When the OK button 48 is depressed, setting for a printing instruction is completed. When the setting for a printing instruction is completed, the rendering data generation unit 23 generates printing instruction data based on document data from the application 18.

As illustrated in FIG. 6B, when a user operates the designation part 41, the UI unit 21 displays the list for the double-sided printing d.

It is assumed that the user selects “designate” for the double-sided printing d in the designation part 41. When the UI unit 21 receives the selection result, the providing information management unit 25 determines, based on apparatus type information stored in the apparatus type information database 31, which of the image forming apparatuses 30a, 30b, and 30c has the printing function corresponding to the double-sided printing d. In this exemplary embodiment, as illustrated in FIG. 4, all the image forming apparatuses 30a, 30b, and 30c have the printing function corresponding to the double-sided printing d. Thus, the providing information management unit 25 receives setting of “designate” for the double-sided printing d.

Then, as illustrated in FIG. 6C, the providing information management unit 25 updates the printing instruction screen 40 so that the display state of the designation part 41 is changed via the UI unit 21. pecifically, the designation part 41 is displayed as “designate”. At this time, the display states of the designation part 42, the designation part 43, and the designation part 44 are not changed.

As illustrated in FIG. 6D, when the user operates the designation part 42, the UI unit 21 displays the list for the saddle-stitch binding with staples a.

It is assumed that the user selects “designate” for the saddle-stitch binding with staples a in the designation part 42. When the UI unit 21 receives the selection result, the providing information management unit 25 determines, based on the apparatus type information database 31, which of the image forming apparatuses 30a, 30b, and 30c has the printing function corresponding to the saddle-stitch binding with staples a. Since the image forming apparatus 30a has the printing function corresponding to the saddle-stitch binding with staples a as illustrated in FIG. 4, the providing information management unit 25 receives setting of “designate” for the saddle-stitch binding with staples a.

Then, as illustrated in FIG. 6E, the providing information management unit 25 updates the printing instruction screen 40 so that the display state of the designation part 42 is changed via the UI unit 21. Specifically, the designation part 42 is displayed as “designate”.

The providing information management unit 25 receives the selection result of “designate” for the saddle-stitch binding with staples a by the user, and determines, based on apparatus type information stored in the apparatus type information database 31, whether the printing functions corresponding to the parts (the designation part 41, the designation part 42, the designation part 43, and the designation part 44) for designating printing functions displayed on the printing instruction screen 40 include a printing function other than the printing functions provided in the image forming apparatus 30a (a function not supported by the image forming apparatus 30a). In this exemplary embodiment, as illustrated in FIG. 4, the image forming apparatus 30a does not have the printing functions corresponding to the glossy printing b and the side-stitch binding with staples c.

As illustrated in FIG. 6E, the providing information management unit 25 updates the printing instruction screen 40 via the UI unit 21, and causes the parts for designating the printing functions corresponding to the glossy printing b and the side-stitch binding with staples c, which are not provided in the image forming apparatus 30a, that is, the designation part 43 and the designation part 44, to be erased from the printing instruction screen 40. As a result, as parts for designating printing functions displayed on the printing instruction screen 40, the designation part 41 and the designation part 42 are left on the printing instruction screen 40.

As described above, by updating the printing instruction screen 40 so that the designation part 43 and the designation part 44 are deleted and printing functions are narrowed down, occurrence of a situation in which the user designates a printing function not provided in the image forming apparatus 30a or the user mistakenly considers the printing function not provided in the image forming apparatus 30a to be designatable, is suppressed.

In the above description, the case where the designation part 43 and the designation part 44 are deleted, that is, the designation part 43 and the designation part 44 are not displayed (concealed), is explained. However, obviously, a different configuration is also possible in which display of the designation part 43 and the designation part 44 dims out, setting (set value) is forcibly changed, a list may not be opened, or a message indicating “not selectable” is displayed and setting is not accepted (setting is invalidated) when a selection is made.

An operation of the printer driver 20 will now be explained in detail.

First, an operation of the printer driver 20 at the time of initial setting will be explained. Next, an operation of the printer driver 20 will be explained in detail.

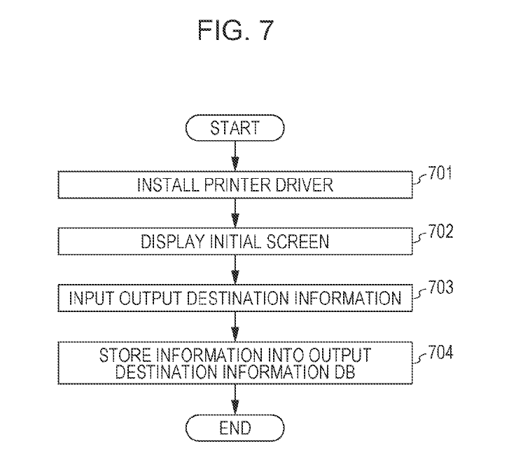

FIG. 7 is a flowchart illustrating an example of the operation of the printer driver 20 at the time of initial setting.

An operation of the printer driver 20 at the time of initial setting will be explained.

First, the printer driver 20 is installed into the terminal apparatus 10 (step 701). Then, the UI unit 21 of the printer driver 20 displays an initial screen for receiving output destination information, which is information regarding an image forming apparatus 30 serving as an output destination (step 702).

The UI unit 21 receives input of the output destination information via the initial screen (step 703). Accordingly, information of the image forming apparatuses 30 connected to the network 80 is set.

Then, the received output destination information is stored into the output destination information database 33 (step 704).

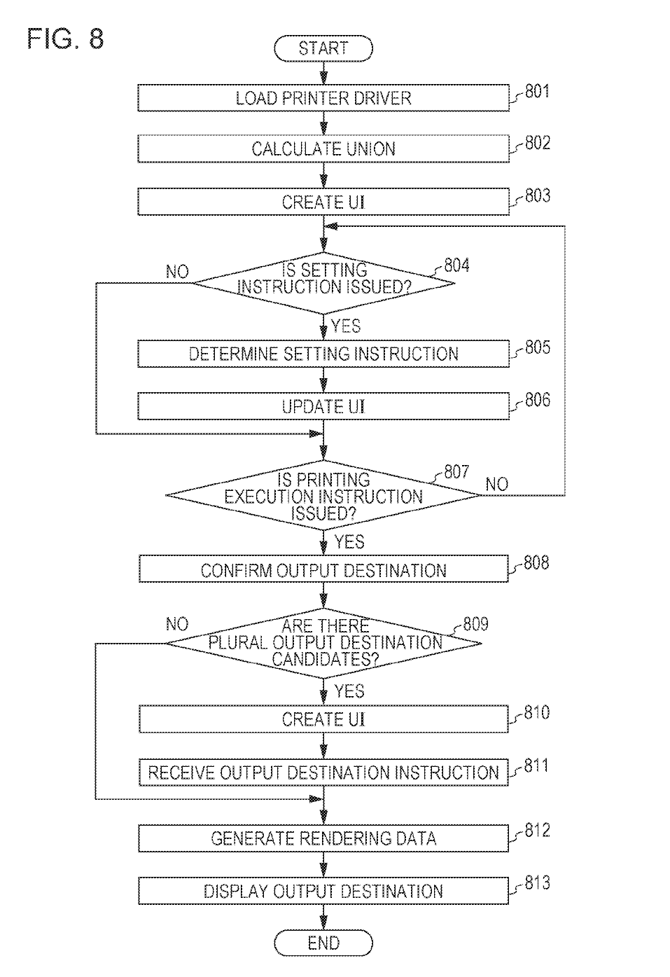

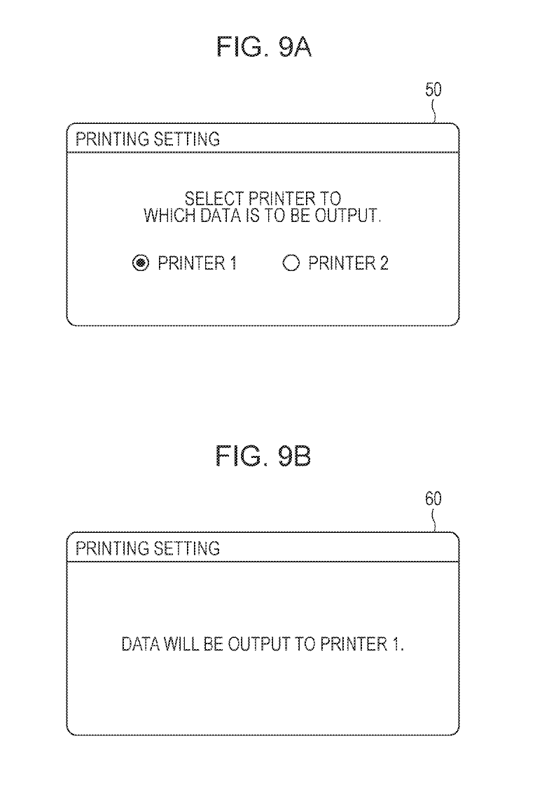

FIG. 8 is a flowchart illustrating an example of the operation of the printer driver 20 at the time of printing. FIGS. 9A and 9B are diagrams illustrating examples of a screen displayed on the display mechanism 15 of the terminal apparatus 10.

An operation of the printer driver 20 at the time of printing will be explained.

First, when a user wants to perform printing, the printer driver 20 is loaded through the application 18 (step 801). After the printer driver 20 is loaded, the providing information management unit 25 calculates the set J (see FIG. 5B), which is the union of the printing functions provided in the output destinations connected to the network 80 (see FIG. 1), that is, the image forming apparatuses 30a, 30b, and 30c, by referring to the apparatus type information database 31 and the output destination information database 33 (step 802).

Next, based on the calculated set J, the UI unit 21 displays the printing instruction screen 40 (see FIG. 6A) on the display mechanism 15 (step 803). At this time, the UI unit 21 displays all of the designation part 41, the designation part 42, the designation part 43, and the designation part 44 for selecting the printing functions (the saddle-stitch binding with staples a, the glossy printing b, the side-stitch binding with staples c, and the double-sided printing d) provided in the image forming apparatuses 30a, 30b, and 30c.

Next, the UI unit 21 determines whether a setting instruction for a printing function is issued from the user (step 804). When a setting instruction for a printing function is issued (Yes in step 804), the providing information management unit 25 performs determination of the setting instruction (step 805). That is, the providing information management unit 25 determines which of the image forming apparatuses 30a, 30b, and 30c has the printing function for which the setting instruction is issued, by making a query to the apparatus type information database 31. In other words, the providing information management unit 25 determines whether or not prohibition conditions are applied. When a setting instruction for a printing function is not issued (No in step 804), the UI unit 21 determines whether or not an instruction for printing execution is issued (step 807, described later).

In accordance with the determination result, the providing information management unit 25 updates the printing instruction screen 40 via the UI unit 21 (step 806). At this time, designation of non-supported functions on the printing instruction screen 40 is restricted by performing processing, such as deleting the designation part 43 and the designation part 44 as illustrated in FIG. 6E, so that printing functions (non-supported functions) other than printing functions provided in the image forming apparatus 30a, 30b, or 30c that is determined to have the printing function for which the setting instruction is received in step 805, are not selectable.

Next, the UI unit 21 determines whether or not an instruction for printing execution is issued from the user via the application 18 (step 807). Specifically, the UI unit 21 determines whether the OK button 48 on the printing instruction screen 40 (see FIG. 6A) is depressed. Although illustration is omitted in FIG. 8, for example, by depressing the cancel button 47 on the printing instruction screen 40 (see FIG. 6A), processing may be terminated without issuing a printing instruction.

When a printing execution instruction is issued (Yes in step 807), the providing information management unit 25 performs confirmation of an image forming apparatus 30 as an output destination (step 808). Specifically, the providing information management unit 25 determines which of the image forming apparatuses 30a, 30b, and 30c is able to provide the printing function for which execution is instructed through the printing instruction, by making a query to the apparatus type information database 31 and the output destination information database 33. The determination result corresponds to the determination result in step 805. When a printing execution instruction is not issued (No in step 807), the UI unit 21 determines whether or not a setting instruction for a printing function is issued from the user (step 804).

When there are plural output destination candidates (Yes in step 809), the output destination determination unit 27 creates a screen 50 (see FIG. 9A) for receiving, from the user via the UI unit 21, a designation of the image forming apparatus 30 that is to perform output, and displays the screen 50 (step 810). The screen 50 includes display for prompting the user to designate which image forming apparatus 30 is to perform output.

When the output destination determination unit 27 receives the designation of the output destination via the UI unit 21 (step 811), the rendering data generation unit 23 generates printing instruction data for instructing the designated image forming apparatus 30 to perform printing based on document data from the application 18, and outputs the generated printing instruction data to the designated image forming apparatus 30 (step 812). Then, the UI unit 21 displays a screen 60 (see FIG. 9B) indicating the image forming apparatus 30 serving as the output destination (step 813).

Further, when there is only one output destination candidate (No in step 809), the rendering data generation unit 23 outputs the printing instruction data to the confirmed image forming apparatus 30 (step 812). Then, the UI unit 21 displays the screen 60 (see FIG. 9B) indicating the image forming apparatus 30 serving as the output destination (step 813).

In this exemplary embodiment, even in the case where a user does not understand which printing function an image forming apparatus 30 has, all the printing functions provided in the image forming apparatus 30 may be used.

Further, in this exemplary embodiment, one printer driver 20 (logical printer) is able to handle all the image forming apparatuses 30 existing over the network 80 of the user, and therefore the management cost may be reduced.

### <Variations>

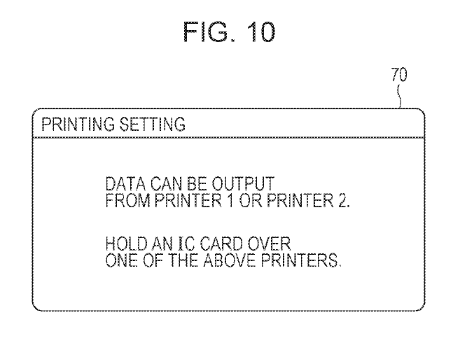

FIG. 10 is a diagram illustrating an example of a screen 70 displayed on the display mechanism 15 of the terminal apparatus 10 according to a variation.

In the description provided above, the case where when there are plural output destination candidates (Yes in step 809 in FIG. 8), a designation of which image forming apparatus 30 is to perform output is received from a user via the UI unit 21 (step 811), is explained. However, the designation of an output destination is not limited to this. For example, a designation of an output destination may be received by a predetermined operation performed by a user on an image forming apparatus 30 from which the user wants to perform output, from among the output destination candidates.

Specifically, when the printer driver 20 is loaded (step 801 in FIG. 8), information of an IC card of a user who wants to use the printer driver 20 is received by the IC card information setting unit 29 via the UI unit 21 or the like and stored in the IC card information setting unit 29.

Then, when there are plural output destination candidates (Yes in step 809 in FIG. 8), the UI unit 21 displays the screen 70 indicating image forming apparatuses 30 from which output is able to be performed, as illustrated in FIG. 10. The screen 70 includes display for prompting the user to hold the IC card over any of the image forming apparatuses 30.

Next, the rendering data generation unit 23 generates printing instruction data, and outputs the generated printing instruction data. The output printing instruction data is stored, for example, in a server (storage device, not illustrated) provided on the network 80.

Then, the user approaches the image forming apparatus 30, from among the image forming apparatuses 30 designated on the screen 70, from which the user wants to perform output, and allows the IC card reading unit 71 to read information held in the IC card and to perform authentication. With this authentication, printing instruction data is transmitted (downloaded) from a server (storage device, not illustrated) provided on the network 80 to the image forming apparatus 30. Then, the image forming apparatus 30 receives the printing instruction data, and performs image formation based on the received printing instruction data.

In the description provided above, the case where the apparatus type information database 31 of the printer driver 20 stores apparatus type information in advance is explained. However, the printer driver 20 is not necessarily configured as described above. For example, the printer driver 20 may be configured to include apparatus type information acquisition unit that acquires apparatus type information via the network 80, instead of the apparatus type information database 31.

Specifically, an external device which is different from the terminal apparatus 10, such as a storage device (not illustrated) on the network 80, stores (holds) apparatus type information. When the providing information management unit 25 refers to the apparatus type information at the time of determination of a setting instruction (step 805 in FIG. 8) or the like, the apparatus type information acquisition unit may acquire the apparatus type information from the external storage device.

Further, the printer driver 20 may include the apparatus type information acquisition unit and the apparatus type information database 31. Obviously, in this case, apparatus type information acquired by the apparatus type information acquisition unit may be stored into the apparatus type information database 31, for example, at the time when the printer driver 20 is installed into the terminal apparatus 10 (step 701 in FIG. 7) or the like.

A program implementing an exemplary embodiment may not only be supplied through communication but also be stored in a recording medium, such as a compact disc-read only memory (CD-ROM), and distributed.

Further, although various variations are explained above, these variations may be combined together.

Further, this application is not limited to any of the foregoing exemplary embodiments and may be implemented by various forms without departing from the scope of this application.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing instruction apparatus comprising:
a display that displays a selection screen for allowing a user to select an execution function, which is a printing function to be executed, from among printing functions provided in a plurality of printing apparatuses;
a reception unit that receives a selection of the execution function; and
a changing unit that changes the selection screen so that, after the reception unit receives the selection of the execution function, a printing function executable by a printing apparatus which has the execution function that has already been received by the reception unit is selectable and the other printing functions are not selectable.

2. The printing instruction apparatus according to claim 1, further comprising a designation unit that receives a designation as to which of a plurality of printing apparatuses is to perform printing in a case where there are the plurality of printing apparatuses that have the execution function received by the reception unit.

3. The printing instruction apparatus according to claim 1, further comprising a cancellation unit that cancels reception of the selection after the reception unit receives the selection of the execution function.

4. The printing instruction apparatus according to claim 1, wherein after the reception unit receives the selection of the execution function, the changing unit erases display for selecting the other printing functions on the selection screen.

5. A printing instruction apparatus comprising:
an acquisition unit that acquires information regarding printing functions provided in a plurality of printing apparatuses;
a reception unit that receives a selection of an execution function, which is a printing function to be executed when printing is performed, from among the printing functions, based on the information regarding the printing functions acquired by the acquisition unit;
an identifying unit that identifies a printing apparatus which has the execution function received by the reception unit, from among the plurality of printing apparatuses; and
a restriction unit that restricts reception by the reception unit so that, after the reception unit receives the selection of the execution function, a printing function executable by the printing apparatus identified by the identifying unit is selectable and the other printing functions are not selectable.

6. The printing instruction apparatus according to claim 1, wherein the printing functions include a function implemented by processing performed by the printing instruction apparatus.

7. The printing instruction apparatus according to claim 5, wherein the printing functions include a function implemented by processing performed by the printing instruction apparatus.

8. The printing instruction apparatus according to claim 1, wherein the printing functions include a function implemented by processing performed by a printing apparatus.

9. The printing instruction apparatus according to claim 5, wherein the printing functions include a function implemented by processing performed by a printing apparatus.

10. The printing instruction apparatus according to claim 1, wherein the printing functions include a function implemented by processing performed by the printing instruction apparatus and a printing apparatus.

11. The printing instruction apparatus according to claim 5, wherein the printing functions include a function implemented by processing performed by the printing instruction apparatus and a printing apparatus.

12. An image forming system comprising:
a plurality of printing apparatuses that perform printing of an image; and
a printing instruction apparatus that instructs the plurality of printing apparatuses to perform printing of the image,
wherein the printing instruction apparatus includes
a display that displays a selection screen for allowing a user to select an execution function, which is a printing function to be executed, from among printing functions provided in the plurality of printing apparatuses,
a reception unit that receives a selection of the execution function, and
a changing unit that changes the selection screen so that, after the reception unit receives the selection of the execution function, a printing function executable by a printing apparatus which has the execution function that has already been received by the reception unit is selectable and the other printing functions are not selectable.

13. A printing instruction method comprising:
displaying a selection screen for allowing a user to select an execution function, which is a printing function to be executed, from among printing functions provided in a plurality of printing apparatuses;
receiving a selection of the execution function; and
changing the selection screen so that, after receiving the selection of the execution function, a printing function executable by a printing apparatus which has the execution function that has already been received is selectable and the other printing functions are not selectable.

14. A non-transitory computer readable medium storing a program causing a computer to execute a process for printing instruction, the process comprising:
displaying a selection screen for allowing a user to select an execution function, which is a printing function to be executed, from among printing functions provided in a plurality of printing apparatuses;
receiving a selection of the execution function; and
changing the selection screen so that, after receiving the selection of the execution function, a printing function executable by a printing apparatus which has the execution function that has already been received is selectable and the other printing functions are not selectable.
